(19) United States
(12) Patent Application Publication
(10) Pub. No.: US 2022/0195179 A1
(43) Pub. Date: Jun. 23, 2022

(54) METHOD FOR IMPROVING ALKALINE SOLUTION RESISTANCE OF THERMOPLASTIC RESINS

(71) Applicant: Polyplastics Co., Ltd., Tokyo (JP)

(72) Inventors: Kouichi Sakata, Fuji-shi (JP); Ryusei Matsuzaki, Fuji-shi (JP)

(73) Assignee: Polyplastics Co., Ltd., Tokyo (JP)

(21) Appl. No.: 17/599,636

(22) PCT Filed: Mar. 24, 2020
(86) PCT No.: PCT/JP2020/012853

§ 371 Date: Sep. 29, 2021

(30) Foreign Application Priority Data
Apr. 1, 2019 (JP) 2019-069661

(51) Int. Cl. C08L 67/02; C08K 5/06; C08J 3/205

(52) U.S. Cl. CPC C08L 67/02; C08K 5/06; C08J 3/2053; C08J 2483/04; C08L 2201/08; C08J 2367/02; C08J 2433/16; C08L 2201/02

(57) ABSTRACT

A method is disclosed for improving alkaline solution resistance of a thermoplastic resin by blending an aromatic polyvalent carboxylic acid ester into the thermoplastic resin. Preferably, 1 to 15 parts by mass of the aromatic polyvalent carboxylic acid ester are blended with respect to 100 parts by mass of the thermoplastic resin. Additionally, an aromatic polyvalent carboxylic acid ester can be used for improving alkaline solution resistance of a thermoplastic resin. An alkaline solution resistance improving agent is also disclosed for a thermoplastic resin, the alkaline solution resistance improving agent containing an aromatic polyvalent carboxylic acid ester.

### TECHNICAL FIELD

The present invention relates to a method for improving the alkaline solution resistance of a thermoplastic resin.

### BACKGROUND

Resin molded articles that are used in environments in which they come into contact with alkaline solutions such as detergents, bleaches, and snow-melting agents are required to have excellent long-term resistance to the alkaline solutions in order to prevent reactions with the alkaline solutions lowering the quality over time. In particular, in resin molded articles that are used in a state in which excessive stress is applied due to screw-fastening, metal press-fitting, crimping, or the like, and in resin molded articles having portions in which stress fractures can easily form, such as thin portions and/or weld line portions, which are resin flow interfaces, cracks and the like form more easily in the above-mentioned portions when the resin molded articles are used in environments in which they come into contact with alkaline solutions. Therefore, there is a stronger requirement for alkaline solution resistance.

As a technology for improving the alkaline solution resistance of thermoplastic resins, there is a technology in which a silicone-based compound and/or a fluorine-based compound is blended into a thermoplastic resin (for example, Patent Document 1). However, when molded articles composed of a thermoplastic resin containing a silicone-based compound are used, for example, in a contact portion or the like for an electrical/electronic component, silicon dioxide can be formed on the surfaces by heat, sparks, or the like, thus causing contact defects.

Meanwhile, plasticizers, mold release agents, and the like are sometimes added to thermoplastic resins in consideration of workability and the like (for example, Patent Document 2).

### CITATION LIST

### Patent Literature

Patent Document 1: WO 00/78867 A1
Patent Document 2: WO 2011/058992 A1

### SUMMARY OF INVENTION

### Technical Problem

The present invention addresses the problem of providing a method for improving the alkaline solution resistance of a thermoplastic resin. The present invention addresses the problem of providing a use of an aromatic polyvalent carboxylic acid ester for improving the alkaline solution resistance of a thermoplastic resin. The present invention addresses the problem of providing an alkaline solution resistance improving agent for a thermoplastic resin.

### Solution to Problem

The present inventors repeatedly carried out diligent research regarding methods capable of improving the alkaline solution resistance of thermoplastic resins without the use of silicone-based compounds, as a result of which they discovered, surprisingly, that the alkaline solution resistance of a thermoplastic resin can be raised by blending an aromatic polyvalent carboxylic acid ester, which is generally used as an additive in thermoplastic resins.

The present invention relates to the subject matter indicated below.

[1] A method for improving alkaline solution resistance of a thermoplastic resin by blending an aromatic polyvalent carboxylic acid ester into the thermoplastic resin.
[2] The method according to [1], wherein the aromatic polyvalent carboxylic acid ester is a compound represented by Formula I:

ϕ-(COOR)n I

wherein, in Formula I, ϕ represents a C₆₋₁₂ arene ring, R represents an alkyl group, a cycloalkyl group, or an aralkyl group, n represents an integer equal to or greater than 2, and the R in each —COOR group may be the same or different.
[3] The method according to either [1] or [2], wherein 1 to 15 parts by mass of the aromatic polyvalent carboxylic acid ester are blended with respect to 100 parts by mass of the thermoplastic resin.
[4] The method according to any one of [1] to [3], wherein 10 to 50 parts by mass of a halogenated organic compound are blended with respect to 100 parts by mass of the thermoplastic resin.
[5] The method according to [4], wherein the halogenated organic compound includes one or more compounds selected from among halogenated polycarbonates and halogenated polyacrylates.
[6] The method according to any one of [1] to [5], wherein 10 to 80 parts by mass of an elastomer are blended with respect to 100 parts by mass of the thermoplastic resin.
[7] Use of an aromatic polyvalent carboxylic acid ester for improving alkaline solution resistance of a thermoplastic resin.
[8] The use according to [7], wherein the aromatic polyvalent carboxylic acid ester is a compound represented by Formula I:

ϕ-(COOR)n I

wherein, in Formula I, ϕ represents a C₆₋₁₂ arene ring, R represents an alkyl group, a cycloalkyl group, or an aralkyl group, n represents an integer equal to or greater than 2, and the R in each —COOR group may be the same or different.
[9] The use according to either [7] or [8], wherein 1 to 15 parts by mass of the aromatic polyvalent carboxylic acid ester are used with respect to 100 parts by mass of the thermoplastic resin.
[10] The use according to any one of [7] to [9], wherein the aromatic polyvalent carboxylic acid ester is used in combination with a halogenated organic compound.
[11] An alkaline solution resistance improving agent for a thermoplastic resin, the alkaline solution resistance improving agent containing an aromatic polyvalent carboxylic acid ester.
[12] The alkaline solution resistance improving agent according to [11], wherein the aromatic polyvalent carboxylic acid ester is a compound represented by Formula I:

ϕ-(COOR)n I

wherein, in Formula I, ϕ represents a C₆₋₁₂ arene ring, R represents an alkyl group, a cycloalkyl group, or an aralkyl group, n represents an integer equal to or greater than 2, and the R in each —COOR group may be the same or different.
[13] The alkaline solution resistance improving agent according to either [11] or [12], wherein 1 to 15 parts by mass of the aromatic polyvalent carboxylic acid ester are used with respect to 100 parts by mass of the thermoplastic resin.
[14] The alkaline solution resistance improving agent according to any one of [11] to [13], containing a halogenated organic compound.
[15] The alkaline solution resistance improving agent according to any one of [11] to [14], for use in combination with a halogenated organic compound.
[16] The alkaline solution resistance improving agent according to any one of [11] to 15] not containing any silicone-based compounds or containing 5% by mass or less of silicone-based compounds.

### Effects of Invention

According to the present invention, a method for improving the alkaline solution resistance of a thermoplastic resin can be provided. According to the present invention, a use of an aromatic polyvalent carboxylic acid ester for improving the alkaline solution resistance of a thermoplastic resin can be provided. According to the present invention, an alkaline solution resistance improving agent for a thermoplastic resin can be provided.

### DESCRIPTION OF EMBODIMENTS

Hereinafter, an embodiment of the present invention will be explained in detail. The present invention is not limited to the embodiment described below, and may be implemented by adding modifications, as appropriate, within a range not hindering the effects of the present invention. In the case in which a specific explanation presented regarding an embodiment also applies to another embodiment, the explanation will be omitted for the other embodiment.

[Method for Improving Alkaline Solution Resistance]

The method for improving alkaline solution resistance according to the present embodiment is a method for improving the alkaline solution resistance of a thermoplastic resin by blending an aromatic polyvalent carboxylic acid ester into the thermoplastic resin. “Alkaline solution resistance” is the property wherein the quality does not tend to become lower even in the case of long-term contact with an alkaline solution. In the present description, the alkaline solution resistance is considered to be excellent in the case in which cracks do not form after a test piece has been immersed for 50 hours or longer in an aqueous sodium hydroxide solution at 23° C.

(Thermoplastic Resin)

The thermoplastic resin is not particularly limited and may, for example, be a polyolefin resin such as high-density polyethylene (HDPE), low-density polyethylene (LDPE), linear low-density polyethylene (LLDPE), or polypropylene; a polyarylene sulfide resin such as polyphenylene sulfide (PPS); a polyester resin such as polybutylene terephthalate (PBT) or polyethylene terephthalate (PET); a polycarbonate resin; a polyacetal (POM) resin; a vinyl resin such as polystyrene, a polyacrylic acid ester, or a polymethacrylic acid ester; a polyamide (PA) resin such as nylon-6 or nylon-66; a polyphenylene ether resin; a polyimide resin; a polyether imide resin; a liquid crystal polymer; or the like. One or more thermoplastic resins selected from the above may be used.

(Aromatic Polyvalent Carboxylic Acid Ester)

The aromatic polyvalent carboxylic acid ester need only be an aromatic compound having two or more ester groups (such as an alkoxycarboxyl group, a cycloalkyloxycarbonyl group, or an aralkyloxycarbonyl group) on an aromatic ring, and may, for example, be a compound represented by Formula I below.

ϕ-(COOR)n I

In Formula I, ϕ represents a C₆₋₁₂ arene ring, R represents an alkyl group, a cycloalkyl group, or an aralkyl group, n represents an integer equal to or greater than 2, and the R in each —COOR group may be the same or different. In 4, the hydrogen atoms other than the hydrogen atom substituted by —COOR may or may not be substituted by other substituent groups. For example, ϕ may have a structure wherein one or more of the hydrogen atoms other than the hydrogen atom substituted by —COOR are substituted by —OH and/or —NH₂. For the purposes of compatibility with the thermoplastic resin, n is preferably 3 or greater (for example, 3 to 6, or 3 or 4). These aromatic polyvalent carboxylic acid esters may be used as a single type or as a combination of two or more types.

The C₆₋₁₂ arene ring may be a benzene ring, a napththalene ring, or the like. The polyvalent carboxylic acid in the aromatic polyvalent carboxylic acid ester component may, for example, be an aromatic dicarboxylic acid (such as phthalic acid, isophthalic acid, terephthalic acid, naphthalene dicarboxylic acid, or an anhydride of the above), an aromatic tricarboxylic acid (such as trimellitic acid or an anhydride thereof), an aromatic tetracarboxylic acid (pyromellitic acid or an anhydride thereof), or the like.

The alkyl group constituting the alkyl ester (—COOR) may, for example, be a linear or branched C₁₋₂₀ alkyl group such as butyl, t-butyl, pentyl, hexyl, octyl, 2-ethylhexyl, an isononyl group, a decyl group, an isodecyl group, or a triisodecyl group. Preferred alkyl groups are linear or branched C₃₋₁₆ alkyl groups, particularly linear or branched C₄₋₁₄ alkyl groups.

Examples of cycloalkyl groups constituting a cycloalkyl ester group include C₅₋₁₀ cycloalkyl groups such as cyclohexyl groups.

The aralkyl groups constituting an aralkyl ester group may be C₆₋₁₂-aryl-C₁₋₄-alkyl groups such as benzyl groups.

Examples of typical aromatic polyvalent carboxylic acid esters include trimellitic acid tri-C₄₋₂₀-alkyl esters (such as tributyl trimellitate, trioctyl trimellitate, tri(2-ethylhexyl) trimellitate, and triisodecyl trimellitate), trimellitic acid tri-C₅₋₁₀-cycloalkyl esters (such as tricyclohexyl trimellitate), triaralkyl trimellitates (such as tribenzyl trimellitate), dialkyl monoaralkyl trimellitates (di(2-ethylhexyl) monobenzyl trimellitate), pyromellitic acid tetra-C₄₋₂₀-alkyl esters (such as tetrabutyl pyromellitate, tetraoctyl pyromellitate, tetra-2-ethylhexyl pyromellitate, and tetraisodecyl pyromellitate), tetraaralkyl pyromellitates (such as tetrabenzyl pyromellitate), dialkyl diaralkyl pyromellitates (such as di(2-ethylhexyl) dibenzyl pyromellitate), and the like. The carboxylic acid esters may be mixed esters including different ester groups (such as alkoxycarboxyl groups, cycloalkyloxycarbonyl groups, and aralkyloxycarbonyl groups).

The blended amount of the aromatic polyvalent carboxylic acid ester is preferably 1 to 15 parts by mass, more preferably 2 to 12 parts by mass, and even more preferably 3 to 10 parts by mass with respect to 100 parts by mass of the thermoplastic resin. By setting the blended amount of the aromatic polyvalent carboxylic acid ester to be at least 1 part by mass with respect to 100 parts by mass of the thermoplastic resin, the alkaline solution resistance can be further improved. By setting the blended amount of the aromatic polyvalent carboxylic acid ester to be not more than 15 parts by mass with respect to 100 parts by mass of the thermoplastic resin, long-term resistance to alkaline solutions can be further obtained, and the occurrence of problems such as the aromatic ester seeping out to the surfaces of molded articles can be suppressed.

(Halogenated Organic Compound)

In the method for improving alkaline solution resistance according to the present embodiment, a halogenated organic compound is preferably further blended in the case in which the flame retardance of the resulting thermoplastic resin composition is to be improved.

The halogenated organic compound may be a halogenated polycarbonate, a halogenated polyacrylate, a halogenated epoxy compound, or the like. Specific examples thereof include brominated polyacrylate compounds, brominated polycarbonate compounds, brominated epoxy compounds, and the like. One or more compounds selected from among brominated polyacrylate compounds and brominated polycarbonate compounds are preferably included for the purposes of being able to provide longer-term resistance to alkaline solutions in addition to flame retardance.

Examples of brominated polyacrylate compounds include polypentabromobenzyl acrylate, polytetrabromobenzyl acrylate, polytribromobenzyl acrylate, polypentabromobenzyl methacrylate, and the like.

Examples of brominated polycarbonate compounds include brominated polycarbonates obtained from brominated bisphenol A, particularly tetrabromobisphenol A or the like. The terminal structure thereof may be a phenyl group, a 4-t-butylphenyl group, a 2,4,6-tribromophenyl group, or the like.

The blended amount of the halogenated organic compound is preferably 10 to 50 parts by mass, more preferably 15 to 40 parts by mass, and even more preferably 20 to 35 parts by mass with respect to 100 parts by mass of the thermoplastic resin. By including a halogenated organic compound in the above-mentioned proportion, the flame retardance of the thermoplastic resin can be improved without compromising the mechanical properties.

(Other Blended Agents)

In the method for improving alkaline solution resistance according to the present embodiment, an additive such as an inorganic filler, an antioxidant, a weatherproofing agent, a molecular weight adjuster, a UV absorber, an antistatic agent, a dye, a pigment, a lubricant, a crystallization promoter, a crystal nucleating agent, a near-IR absorber, a flame retardant, a flame retardance aid (for example, antimony trioxide), an organic filler, a colorant, or the like may be further blended into the thermoplastic resin, as needed, within a range not hindering the effects of the present invention. Since the above-mentioned aromatic polyvalent carboxylic acid ester can also function as a plasticizer, there is normally no need to add a plasticizer. However, another plasticizer such as a fatty acid ester may be included as needed. The amount of the plasticizer that is included in that case may be 0.01 to 10 parts by mass with respect to 100 parts by mass of the thermoplastic resin.

Inorganic fillers include fibrous inorganic fillers such as glass fibers; powdered inorganic fillers such as silica, quartz powder, or glass beads; flaky fillers such as mica or glass flakes; and the like. The blended amount of the inorganic filler should preferably be 5 to 200 parts by mass, more preferably 20 to 100 parts by mass with respect to 100 parts by mass of the thermoplastic resin for the purposes of increasing the strength of the molded articles.

Furthermore, an alloy material may be blended into the thermoplastic resin in order to improve other properties of the thermoplastic resin, such as heat shock resistance and tracking resistance. Examples of alloy materials include elastomers such as thermoplastic elastomers and core-shell elastomers; fluorine-based resins; polyolefins; polyamides; and the like. One or more alloy materials selected from the above may be used.

Examples of thermoplastic elastomers include olefin-based elastomers, styrene-based elastomers, polyester-based elastomers, and the like, which may be grafted. Specific examples of thermoplastic elastomers include, for example, propylene-ethylene copolymers, ethylene-ethyl acrylate copolymers (EEA), graft copolymers of ethylene-ethyl acrylate and butyl acrylate-methyl methacrylate (EEA-g-BAMMA copolymers), maleic anhydride (MAH)-modified polyolefins, and the like.

Examples of core-shell elastomers include methyl methacrylate-butyl acrylate copolymers and the like. For the purpose of being able to provide longer-term resistance to alkaline solutions, the core-shell elastomers preferably do not have glycidyl groups. If an elastomer having glycidyl groups is used, then the blended amount thereof should preferably be less than 30 parts by mass with respect to 100 parts by mass of the thermoplastic resin.

Examples of fluorine-based resins include polytetrafluoroethylene (PTFE) and the like. Examples of polyolefins include polyethylene, cyclic polyolefins, copolymers thereof, and the like.

Examples of polyamides include nylon-6 (PA6), nylon-11, nylon-12, nylon-66, and the like.

The blended amount of the elastomer should preferably be 10 to 80 parts by mass and more preferably 10 to 50 parts by mass with respect to 100 parts by mass of the thermoplastic resin. By setting the blended amount to be in the above-mentioned ranges, other properties such as heat shock resistance and tracking resistance can be improved while maintaining the effect of improving alkaline solution resistance.

Furthermore, a component for further improving the hydrolysis resistance may be further blended into the thermoplastic resin in order to improve the hydrolysis resistance of the thermoplastic resin. Examples of components for improving hydrolysis resistance include epoxy compounds, carbodiimide compounds, and the like.

Examples of epoxy compounds include aromatic epoxy compounds such as biphenyl-type epoxy compounds, bisphenol A-type epoxy compounds, phenol novolac-type epoxy compounds, and cresol novolac-type epoxy compounds. One or more compounds selected from the above may be used. An arbitrary combination of two or more epoxy compounds may be used. The epoxy equivalent weight should preferably be 600 to 1500 g/eq. The epoxy equivalent weight is a value measured by potentiometric titration in glacial acetic acid and cetyltrimethylammonium bromide in accordance with the JIS K-7236 standard.

Carbodiimide compounds are compounds having carbodiimide groups (—N═C═N—) in the molecules. Examples of carbodiimide compounds include aliphatic carbodiimide compounds having an aliphatic main chain, alicyclic carbodiimide compounds having an alicyclic main chain, and aromatic carbodiimide compounds having an aromatic main chain. One or more compounds selected from the above may be used.

The blended amount of the carbodiimide compound is preferably 0.1 to 10 parts by mass, more preferably 0.5 to 8 parts by mass, and even more preferably 1 to 4 parts by mass with respect to 100 parts by mass of the thermoplastic resin. By setting the blended amount of the carbodiimide compound to be within the above-mentioned ranges, hydrolysis resistance can be provided without significantly compromising the resistance of the thermoplastic resin to alkaline solutions.

According to the method for improving the alkaline solution resistance according to the present embodiment, the alkaline solution resistance of the thermoplastic resin can be improved without using silicone-based compounds. Thus, the blended amount of silicone-based compounds should preferably be 1% by mass or less, more preferably 0.5% by mass or less, and even more preferably 0.1% by mass or less with respect to the thermoplastic resin composition. The method can also be configured so that silicone-based compounds are not blended. Examples of silicone-based compounds include silicone resins such as dimethylpolysiloxane, methylphenylpolysiloxane, and diphenylpolysiloxane, which are known as silicone oils; modified silicones obtained by reacting silicone resins with modifying resins such as alkyd resins, polyester resins, acrylic resins, and epoxy resins; and the like.

(Blending Method)

The method for blending the aromatic polyvalent carboxylic acid ester and the blended agents that are added, as needed, to the thermoplastic resin is not particularly limited, and preparation can easily be implemented by using conventional resin composition preparation methods, and equipment and methods that are generally used as molding methods. For example, it is possible to use any one of: 1) a method of mixing the resin components and the other components, then preparing pellets by kneading and extruding the components by means of a single-screw or twin-screw extruder, and then molding; 2) a method of first preparing pellets of different compositions, mixing prescribed amounts of those pellets and molding, and after molding, obtaining molded articles with the target compositions; 3) a method of directly loading one or more of the components into a molding machine; or the like. Additionally, a method in which some of the resin components are formed into a fine powder, mixed with the other components, and added is a method that is preferable for ensuring that these components are homogeneously blended.

In the case in which the components are to be kneaded and pelletized in an extruder, the resin temperature (processing temperature) in the extruder may be set, as appropriate, in accordance with the type of resin used. However, the extruder cylinder temperature should preferably be set so that the resin temperature is 350° C. or lower due to the possibility of the mechanical properties being degraded by thermal decomposition. For the purposes of allowing the resin and the aromatic polyvalent carboxylic acid ester to sufficiently react so as to obtain alkaline solution resistance and so as to obtain other physical properties, the extruder cylinder temperature should preferably be set so that the resin temperature in the extruder is 150 to 330° C. and more preferably 200 to 300° C.

The above-mentioned method is preferably a method for keeping cracks from forming after an 80 mm×10 mm×1 mm thick thermoplastic resin test piece having a weld line in the approximate center in the lengthwise direction has been immersed for at least 50 hours in a sodium hydroxide solution at 23° C. in a flexed state in which 1.0% bending strain is constantly applied to the weld line portion, more preferably being a method for keeping cracks from forming after having been immersed for at least 70 hours, even more preferably being a method for keeping cracks from forming after having been immersed for at least 100 hours, and particularly preferably being a method for keeping cracks from forming after having been immersed for at least 200 hours.

(Resin Molded Article)

The thermoplastic resin in which an aromatic polyvalent carboxylic acid ester has been blended by the above-described method has excellent alkaline solution resistance. Thus, molded articles thereof can be widely used in applications requiring alkaline solution resistance. For example, the molded articles can be favorably used as components, among automotive components, electrical/electronic components, and the like, which come into contact with alkaline solutions such as detergents and snow-melting agents. The method for obtaining the resin molded articles is not particularly limited, and a known method may be employed. For example, the molded articles can be produced by loading, into an extruder, a resin in which an aromatic polyvalent carboxylic acid ester has been blended by the above-described method, melting and kneading the resin to form pellets, loading these pellets into an injection molding machine equipped with a prescribed mold, and injection-molding the resin.

[Use of Aromatic Polyvalent Carboxylic Acid Ester]

The use of an aromatic polyvalent carboxylic acid ester according to the present embodiment is a use of an aromatic polyvalent carboxylic acid ester for improving the alkaline solution resistance of a thermoplastic resin. The above-mentioned use is preferably a use for keeping cracks from forming after a test piece as described above has been immersed for at least 50 hours in a sodium hydroxide solution at 23° C. in a flexed state in which 1.0% bending strain is constantly applied to the weld line portion, more preferably being a use for keeping cracks from forming after having been immersed for at least 70 hours, even more preferably being a use for keeping cracks from forming after having been immersed for at least 100 hours, and particularly preferably being a use for keeping cracks from forming after having been immersed for at least 200 hours. The specifics such as the types of aromatic polyvalent carboxylic acid esters and thermoplastic resins are as described above. Thus, the descriptions thereof will be omitted. The amount of the aromatic polyvalent carboxylic acid ester that is used is also the same as the blended amount of the aromatic polyvalent carboxylic acid ester described above.

[Alkaline Solution Resistance Improving Agent]

The alkaline solution resistance improving agent according to the present embodiment is for use by being blended into a thermoplastic resin, and contains an aromatic polyvalent carboxylic acid ester. The amount of the aromatic polyvalent carboxylic acid ester contained in the alkaline solution resistance improving agent is preferably at least 50% by mass, preferably at least 70% by mass, may be at least 80% by mass or at least 90% by mass, and may be configured so as to consist only of the aromatic polyvalent carboxylic acid ester. The alkaline solution resistance improving agent may contain the halogenated organic compounds described above, or other blended agents that can be blended with the thermoplastic resin as described above. The blended amount thereof is not particularly limited, and may, for example, be a total of less than 50% by mass, 30% by mass or less, 20% by mass or less, or 10% by mass or less.

The alkaline solution resistance improving agent according to the present embodiment can improve the alkaline solution resistance of a thermoplastic resin even if a silicone-based compound is not used, and thus may be configured so as not to contain a silicone-based compound or so that the amount of silicone-based compounds contained therein is less than 5% by mass.

The above-mentioned alkaline solution resistance improving agent is preferably an alkaline solution resistance improving agent that keeps cracks from forming after a test piece as described above has been immersed for at least 50 hours in a sodium hydroxide solution at 23° C. in a flexed state in which 1.0% bending strain is constantly applied to the weld line portion, more preferably being an alkaline solution resistance improving agent that keeps cracks from forming after having been immersed for at least 70 hours, even more preferably being an alkaline solution resistance improving agent that keeps cracks from forming after having been immersed for at least 100 hours, and particularly preferably being an alkaline solution resistance improving agent that keeps cracks from forming after having been immersed for at least 200 hours.

The specifics such as the types of aromatic polyvalent carboxylic acid esters and thermoplastic resins are as described above. Thus, the descriptions thereof will be omitted. The amount of the alkaline solution resistance improving agent that is used may be an amount such that the amount of the aromatic polyvalent carboxylic acid ester in the alkaline solution resistance improving agent becomes the blended amount described above with respect to the thermoplastic resin.

### EXAMPLES

Hereinafter, the present invention will be explained in further detail by describing examples. However, the present invention should not be construed in a limiting manner due to these examples.

In each example and comparative example, the thermoplastic resins and aromatic polyvalent carboxylic acid esters indicated in Table 1 were blended, together with blended agents that were used as needed, in the amounts (parts by mass) indicated in Table 1, then melted and kneaded using a twin-screw extruder (manufactured by The Japan Steel Works, Ltd.) having a 30 mmϕ screw, with a cylinder temperature of 260° C., to obtain a resin composition in pellet form.

The specifics regarding the respective components that were used are as indicated below.

### (1) Thermoplastic Resin

PBT1: PBT resin (specific viscosity 0.77 dL/g, terminal carboxyl group content 28 meq/kg) manufactured by Wintech Polymer Ltd.

### (2) Aromatic Polyvalent Carboxylic Acid Ester

Pyromellitic acid mixed linear alkyl ester: Adekacizer UL-100 manufactured by Adeka Corp.
Comparative component 1: Benzoic acid ester (polycaprolactone dibenzoate, “Placcel BCL2” manufactured by Daicel Corp.)
Comparative component 2: Polyethylene (low-molecular-weight polyethylene, “Sanwax 161-P” manufactured by Sanyo Chemical Industries, Ltd.)
Comparative component 3: Fatty acid ester (pentaerythritol distearate, “Unister H476” manufactured by NOF Corp.)

### (3) Filler

Glass fiber: “ECS03T-127” (fiber diameter 13 μm) manufactured by Nippon Electric Glass Co., Ltd.

### (4) Elastomer

EEA: ethylene content 75% by mass, melting point 91° C., manufactured by Nippon Unicar Co., Ltd.
EEA-g-BAMMA: Modiper A5300 manufactured by NOF Corp.
Core-shell elastomer not containing glycidyl groups: Paraloid EXL2311 manufactured by Dow Chemical Japan
Core-shell elastomer containing glycidyl groups: Paraloid EXL2314 manufactured by Dow Chemical Japan

### (5) Halogenated Organic Compound

Brominated acrylate: FR-1025 manufactured by Bromochem Far East Co., Ltd. Brominated epoxy: KBE-3010K manufactured by Kaimei Chemical Science and Technology Co., Ltd.
Brominated polycarbonate: Fireguard 7500 manufactured by Teijin Ltd.

### (6) Hydrolysis Resistance Improving Agent

Epoxy compound: Epicoat JER1004K manufactured by Mitsubishi Chemical Corp. Aliphatic carbodiimide: Carbodilite LA-1 manufactured by Nisshinbo Chemical Inc. Aromatic carbodiimide: Stabaxol P-100 manufactured by Lanxess

### (7) Other Blended Agents

Antimony trioxide: Patox-M manufactured by Nihon Seiko Co., Ltd.
PTFE: Polytetrafluoroethylene (Fluon CD097E manufactured by AGC Inc.)

<Evaluation>

(Alkaline Solution Resistance)

After drying pellets of the resin composition at 140° C. for 3 hours, the resin composition was injection-molded using a test piece-forming mold (a mold for forming a plate with a length of 80 mm, a width of 80 mm, and a thickness of 1 mm, with a pin installed at a position corresponding to the approximate center of one main surface of the plate so that a weld line was created on one main surface of the plate when the mold was filled with a resin from a side gate having a width of 2 mm and a thickness of 1 mm provided at the center of a side surface on one side of the plate) with a cylinder temperature of 250° C., a mold temperature of 70° C., an injection time of 20 seconds, and a cooling time of 10 seconds, thereby producing a molded plate article with a weld line. The resulting molded plate article with a weld line was prepared into test pieces by being cut into strips having a width of 10 mm and a length of 80 mm so that the weld line was at the approximate center in the lengthwise direction. These test pieces were fixed with clamps in a flexed state so that a bending strain of 1.0% was constantly applied to the weld line portions. While kept in this state, the test pieces were immersed, together with the clamps, in a 10% sodium hydroxide solution, placed at rest with the ambient temperature at 23° C., then visually observed regarding whether or not cracks formed in the test pieces 72 hours, 120 hours, and 240 hours after initial immersion.

The evaluations were performed by using three test pieces each for the pellets of the examples and the comparative examples. The alkaline solution resistance was evaluated as “1” if no cracks formed in any of the three test pieces, and as “2” if a crack formed in any one of the three test pieces. The results are shown in Table 1.

(Flame Retardance)

After drying pellets of the resin composition for 3 hours at 140° C., the resin composition was injection-molded with a cylinder temperature of 250° C. and a mold temperature of 70° C. to prepare test pieces having a thickness of 1/32 inches, which were evaluated for flame retardance in accordance with the UL94 standard. The results are shown in Table 1.

TABLE 1

| | | Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| PBT | | 100 | 100 | 100 | 100 | 100 | 100 | 100 | 100 | 100 | 100 | 100 |
| Filler | Glass fiber | 69.3 | 70.9 | 70.9 | 70.9 | 70.9 | 70.9 | 70.9 | 86.2 | 64.1 | 69.3 | 70.9 |
| Alkaline solution | Pyromellitic acid | 6.9 | 7.1 | 7.1 | 7.1 | 7.1 | 7.1 | 7.1 | 8.6 | 6.4 | 6.9 | 7.1 |
| resistance | ester | | | | | | | | | | | |
| improving agent | | | | | | | | | | | | |
| Benzoic acid | Polycaprolactone | | | | | | | | | | | |
| ester | dibenzoate | | | | | | | | | | | |
| Polyethylene | Low-molecular- | | | | | | | | | | | |
| | weight polyethylene | | | | | | | | | | | |
| Fatty acid ester | Pentaerythritol | | | | | | | | | | | |
| | distearate | | | | | | | | | | | |
| Elastomer | EEA-g-BAMMA | 16.2 | 16.5 | 16.5 | 16.5 | | | | 43.1 | 6.4 | 16.2 | 16.5 |
| | EEA | | | | | 16.5 | | | | | | |
| | Core-shell elastomer | | | | | | 16.5 | | | | | |
| | (no glycidyl groups) | | | | | | | | | | | |
| | Core-shell elastomer | | | | | | | 16.5 | | | | |
| | (with glycidyl groups) | | | | | | | | | | | |
| Halogenated | Brominated acrylate | 26.6 | 27.2 | 27.2 | 27.2 | 27.2 | 27.2 | 27.2 | 33.0 | 24.6 | | |
| organic | Brominated epoxy | | | | | | | | | | 26.6 | |
| compound | Brominated | | | | | | | | | | | 27.2 |
| | polycarbonate | | | | | | | | | | | |
| Hydrolysis | Epoxy | | 2.4 | | | | | | | | | |
| resistance | Aliphatic | | | 2.4 | | | | | | | | |
| improving agent | carbodiimide | | | | | | | | | | | |
| | Aromatic | | | | 2.4 | 2.4 | 2.4 | 2.4 | 1.4 | 1.1 | 2.3 | 2.4 |
| | carbodiimide | | | | | | | | | | | |
| Other blended | Antimony trioxide | 10.9 | 11.1 | 11.1 | 11.1 | 11.1 | 11.1 | 11.1 | 13.5 | 10.0 | 8.5 | 11.1 |
| agents | PTFE | 1.2 | 1.2 | 1.2 | 1.2 | 1.2 | 1.2 | 1.2 | 1.4 | 1.1 | 1.2 | 1.2 |
| Alkaline solution | 3 days (72 hours) | 1 | 1 | 1 | 1 | 1 | 1 | 1 | 1 | 1 | 1 | 1 |
| resistance test | 5 days (120 hours) | 1 | 1 | 1 | 1 | 1 | 1 | 1 | 1 | 2 | 2 | 1 |
| crack formation | 10 days (240 hours) | 1 | 1 | 1 | 1 | 1 | 1 | 2 | 1 | 2 | 2 | 1 |
| Flame retardance | UL-94 | V-0 | V-0 | V-0 | V-0 | V-0 | V-0 | V-0 | V-0 | V-0 | V-0 | V-0 |

| | | Example | | | | | Comparative Example | | | | |
|---|---|---|---|---|---|---|---|---|---|---|---|
| | | 12 | 13 | 14 | 15 | 16 | 1 | 3 | 4 | 5 | 6 |
| PBT | | 100 | 100 | 100 | 100 | 100 | 100 | 100 | 100 | 100 | 100 |
| Filler | Glass fiber | 72.6 | 50.4 | 51.3 | 55.8 | 123.8 | 66.2 | 70.9 | 70.9 | 70.9 | 70.9 |
| Alkaline solution | Pyromellitic acid | 7.3 | 5.0 | 5.1 | 5.6 | 9.3 | 0.0 | | | | |
| resistance | ester | | | | | | | | | | |
| improving agent | | | | | | | | | | | |
| Benzoic acid | Polycaprolactone | | | | | | | 7.1 | | | |
| ester | dibenzoate | | | | | | | | | | |
| Polyethylene | Low-molecular- | | | | | | | | 7.1 | | |
| | weight polyethylene | | | | | | | | | | |
| Fatty acid ester | Pentaerythritol | | | | | | | | | 7.1 | 7.1 |
| | distearate | | | | | | | | | | |
| Elastomer | EEA-g-BAMMA | 16.9 | 11.8 | 12.0 | 13.0 | 16.5 | 15.5 | 16.5 | 16.5 | 16.5 | 16.5 |
| | EEA | | | | | | | | | | |
| | Core-shell elastomer | | | | | | | | | | |
| | (no glycidyl groups) | | | | | | | | | | |
| | Core-shell elastomer | | | | | | | | | | |
| | (with glycidyl groups) | | | | | | | | | | |
| Halogenated | Brominated acrylate | 27.8 | | | | 21.7 | 25.4 | 27.2 | 27.2 | 27.2 | 27.2 |
| organic | Brominated epoxy | | | | | | | | | | |
| compound | Brominated | | | | | | | | | | |
| | polycarbonate | | | | | | | | | | |
| Hydrolysis | Epoxy | | | | | | | | | | |
| resistance | Aliphatic | | | | | | | | | | |
| improving agent | carbodiimide | | | | | | | | | | |
| | Aromatic | 4.8 | | 1.7 | 1.9 | 3.1 | 2.2 | 2.4 | 2.4 | 2.4 | |
| | carbodiimide | | | | | | | | | | |
| Other blended | Antimony trioxide | 11.4 | | | 8.7 | 14.6 | 10.4 | 11.1 | 11.1 | 11.1 | 11.1 |
| agents | PTFE | 1.2 | 0.8 | 0.9 | 0.9 | 1.5 | 1.1 | 1.2 | 1.2 | 1.2 | 1.2 |
| Alkaline solution | 3 days (72 hours) | 1 | 1 | 1 | 1 | 1 | 2 | 2 | 2 | 2 | 2 |
| resistance test | 5 days (120 hours) | 1 | 1 | 1 | 1 | 1 | 2 | 2 | 2 | 2 | 2 |
| crack formation | 10 days (240 hours) | 2 | 2 | 2 | 2 | 1 | 2 | 2 | 2 | 2 | 2 |
| Flame retardance | UL-94 | V-0 | HB | HB | HB | V-0 | V-0 | V-0 | V-0 | V-0 | V-0 |

Amount units: parts by mass

1. A method for improving alkaline solution resistance of a thermoplastic resin by blending an aromatic polyvalent carboxylic acid ester into the thermoplastic resin.

2. The method according to claim 1, wherein the aromatic polyvalent carboxylic acid ester is a compound represented by Formula I:
ϕ-(COOR)ₙ I
wherein, in Formula I, ϕ represents a C₆₋₁₂ arene ring, R represents an alkyl group, a cycloalkyl group, or an aralkyl group, n represents an integer equal to or greater than 2, and the R in each —COOR group may be the same or different.

3. The method according to claim 1, wherein 1 to 15 parts by mass of the aromatic polyvalent carboxylic acid ester are blended with respect to 100 parts by mass of the thermoplastic resin.

4. The method according to claim 1, wherein 10 to 50 parts by mass of a halogenated organic compound are blended with respect to 100 parts by mass of the thermoplastic resin.

5. The method according to claim 4, wherein the halogenated organic compound includes one or more compounds selected from among halogenated polycarbonates and halogenated polyacrylates.

6. The method according to claim 1, wherein 10 to 80 parts by mass of an elastomer are blended with respect to 100 parts by mass of the thermoplastic resin.

7. (canceled)

8. (canceled)

9. (canceled)

10. (canceled)

11. An alkaline solution resistance improving agent for a thermoplastic resin, the alkaline solution resistance improving agent containing an aromatic polyvalent carboxylic acid ester.

12. The alkaline solution resistance improving agent according to claim 11, wherein the aromatic polyvalent carboxylic acid ester is a compound represented by Formula I:
ϕ-(COOR)ₙ I
wherein, in Formula I, ϕ represents a C₆₋₁₂ arene ring, R represents an alkyl group, a cycloalkyl group, or an aralkyl group, n represents an integer equal to or greater than 2, and the R in each —COOR group may be the same or different.

13. The alkaline solution resistance improving agent according to claim 11, wherein 1 to 15 parts by mass of the aromatic polyvalent carboxylic acid ester are used with respect to 100 parts by mass of the thermoplastic resin.

14. The alkaline solution resistance improving agent according to claim 11, containing a halogenated organic compound.

15. The alkaline solution resistance improving agent according to claim 11, for use in combination with a halogenated organic compound.

16. The alkaline solution resistance improving agent according to claim 11, not containing any silicone-based compounds or containing 5% by mass or less of silicone-based compounds.

17. The method according to claim 4, wherein 10 to 80 parts by mass of an elastomer are blended with respect to 100 parts by mass of the thermoplastic resin.
